(19) United States
(12) Patent Application Publication
(10) Pub. No.: US 2022/0058387 A1
(43) Pub. Date: Feb. 24, 2022

(54) INFORMATION PROCESSING APPARATUS AND NON-TRANSITORY COMPUTER READABLE MEDIUM

(71) Applicant: FUJIFILM BUSINESS INNOVATION CORP., Tokyo (JP)

(72) Inventor: Tian NIE, Kanagawa (JP)

(73) Assignee: FUJIFILM BUSINESS INNOVATION CORP., Tokyo (JP)

(21) Appl. No.: 17/164,368

(22) Filed: Feb. 1, 2021

(30) Foreign Application Priority Data
Aug. 18, 2020 (JP) 2020-138008

(51) Int. Cl. G06K 9/00; G06K 9/62; G06F 40/166; G06N 20/00; G06F 16/93

(52) U.S. Cl. CPC G06K 9/00469; G06K 9/00456; G06K 9/6228; G06K 9/00483; G06F 16/93; G06K 9/6256; G06F 40/166; G06N 20/00; G06K 9/626

(57) ABSTRACT

An information processing apparatus includes a processor configured to, in classification of a target document according to at least one classification criterion, extract significant terms from classification-criterion terms on the basis of the degrees of significance of the classification-criterion terms relative to target-document terms, the classification-criterion terms being included in the at least one classification criterion, the target-document terms being included in the target document.

### CROSS-REFERENCE TO RELATED APPLICATIONS

This application is based on and claims priority under 35 USC 119 from Japanese Patent Application No. 2020-138008 filed Aug. 18, 2020.

### BACKGROUND

### (i) Technical Field

The present disclosure relates to an information processing apparatus and a non-transitory computer readable medium.

### (ii) Related Art

Japanese Unexamined Patent Application Publication No. 2018-194881 discloses a document classification system which classifies documents. The document classification system includes model information prepared by reading classified documents as training data. The document classification system includes a classification unit that reads a target document which has not been classified, and that uses the model information to classify the target document into multiple classification groups. The document classification system outputs words or sentences of the target document which are the basis of the classification of the target document.

### SUMMARY

Aspects of non-limiting embodiments of the present disclosure relate to an information processing apparatus and a non-transitory computer readable medium which enable significant terms to be extracted from classification criteria when a classification target document is to be classified according to the classification criteria.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor configured to, in classification of a target document according to at least one classification criterion, extract significant terms from classification-criterion terms on the basis of the degrees of significance of the classification-criterion terms relative to target-document terms. The classification-criterion terms are included in the at least one classification criterion. The target-document terms are included in the target document.

### BRIEF DESCRIPTION OF THE DRAWINGS

Exemplary embodiments of the present disclosure will be described in detail based on the following figures, wherein:

FIG. 1 is a block diagram illustrating an exemplary configuration of an information processing system according to an exemplary embodiment;

FIG. 2 is a block diagram illustrating an exemplary hardware configuration of an information processing apparatus according to an exemplary embodiment;

FIG. 3 is a block diagram illustrating an exemplary functional configuration of an information processing apparatus according to a first exemplary embodiment;

FIG. 4 is a schematic diagram illustrating an exemplary configuration of a document classification model according to an exemplary embodiment;

FIG. 5 is a view of the front side of a target document example according to an exemplary embodiment;

FIG. 6 is a view of the front side of a manual document example according to an exemplary embodiment;

FIG. 7 is a schematic diagram illustrating an exemplary configuration of a target-document database according to an exemplary embodiment;

FIG. 8 is a schematic diagram illustrating an exemplary configuration of a manual-document database according to first and second exemplary embodiments;

FIG. 9 is a flowchart of an exemplary model generation process according to the first and second exemplary embodiments;

FIG. 10 is a flowchart of an exemplary document classification process according to the first exemplary embodiment;

FIG. 11 is a schematic diagram which is used to describe a document classification process according to an exemplary embodiment, and which illustrates an exemplary state of estimation of probabilities of correspondence between a target document and multiple manual documents;

FIG. 12 is a diagram illustrating an exemplary configuration of a classification result screen according to an exemplary embodiment;

FIG. 13 is a diagram illustrating an exemplary configuration of a summary screen according to an exemplary embodiment;

FIG. 14 is a block diagram illustrating an exemplary functional configuration of an information processing apparatus according to the second exemplary embodiment;

FIG. 15 is a flowchart of an exemplary document classification process according to the second exemplary embodiment;

FIG. 16 is a diagram illustrating an exemplary configuration of a manual-document presentation screen according to the second exemplary embodiment;

FIG. 17 is a block diagram illustrating an exemplary functional configuration of an information processing apparatus according to a third exemplary embodiment;

FIG. 18 is a schematic diagram illustrating an exemplary configuration of a manual-document database according to the third exemplary embodiment;

FIG. 19 is a flowchart of an exemplary model generation process according to the third exemplary embodiment; and

FIG. 20 is a flowchart of an exemplary document classification process according to the third exemplary embodiment.

### DETAILED DESCRIPTION

Referring to the drawings, exemplary embodiment of the present disclosure will be described in detail below. The present exemplary embodiment will describe the case in which manual documents are used as classification criteria according to the exemplary embodiment of the present disclosure, and in which, as an estimation system according to the exemplary embodiment of the present disclosure, an estimation system including a document classification model for classifying a target document as one of the documents indicated by multiple manual documents is used.

### First Exemplary Embodiment

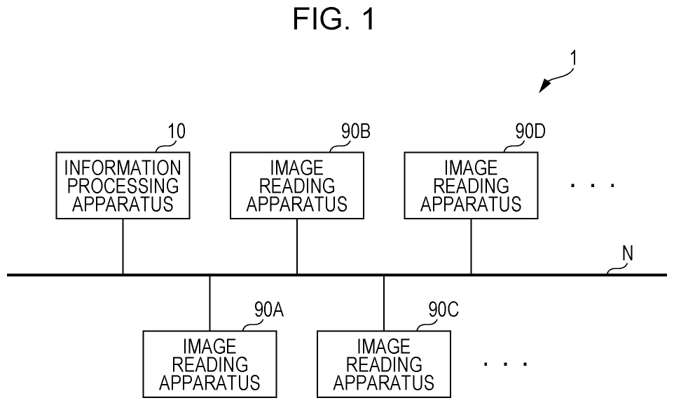

Referring to FIG. 1, the configuration of an information processing system 1 according to a first exemplary embodiment will be described. FIG. 1 is a block diagram illustrating an exemplary configuration of the information processing system 1 according to the first exemplary embodiment.

As illustrated in FIG. 1, the information processing system 1 according to the first exemplary embodiment includes an information processing apparatus 10 which plays a leading role in the system, and multiple image reading apparatuses 90A, 90B, . . . . In the description below, if the image reading apparatuses 90A, 90B, . . . are described without discrimination, they are collectively referred to simply as “image reading apparatuses 90”.

The information processing apparatus 10 according to the first exemplary embodiment uses a document classification model 13C, which is described below, to derive probabilities of correspondence between a target document, which is input through an image reading apparatus 90, and the documents indicated by pre-registered manual documents. The information processing apparatus 10 according to the first exemplary embodiment performs various processes using derived probabilities and information obtained in the process of deriving the probabilities.

The information processing apparatus 10 is connected to the image reading apparatuses 90 over a network N. The information processing apparatus 10 is capable of performing two-way communication with the image reading apparatuses 90 over the network N. In the first exemplary embodiment, in-house communication lines, such as a local area network (LAN) or a wide area network (WAN), are used as the network N. However, this is not limiting. For example, public communication lines, such as the Internet or telephone lines, may be used as the network N, or a combination of in-house communication lines and public communication lines may be used. In the first exemplary embodiment, wired communication lines are used as the network N. However, this is not limiting. Wireless communication lines may be used, or a combination of wired and wireless communication lines may be used.

In the first exemplary embodiment, a so-called scanner, which simply has only the image reading function, is used as an image reading apparatus 90. However, this is not limiting. For example, a digital multifunction device having the image print function, the image reading function, and the image transmission function may be used as an image reading apparatus 90. In the first exemplary embodiment, the case in which the information processing apparatus 10 and each image reading apparatus 90 are formed separately from each other will be described. However, this configuration is not limiting. The information processing apparatus 10 may be integrated with each image reading apparatus 90.

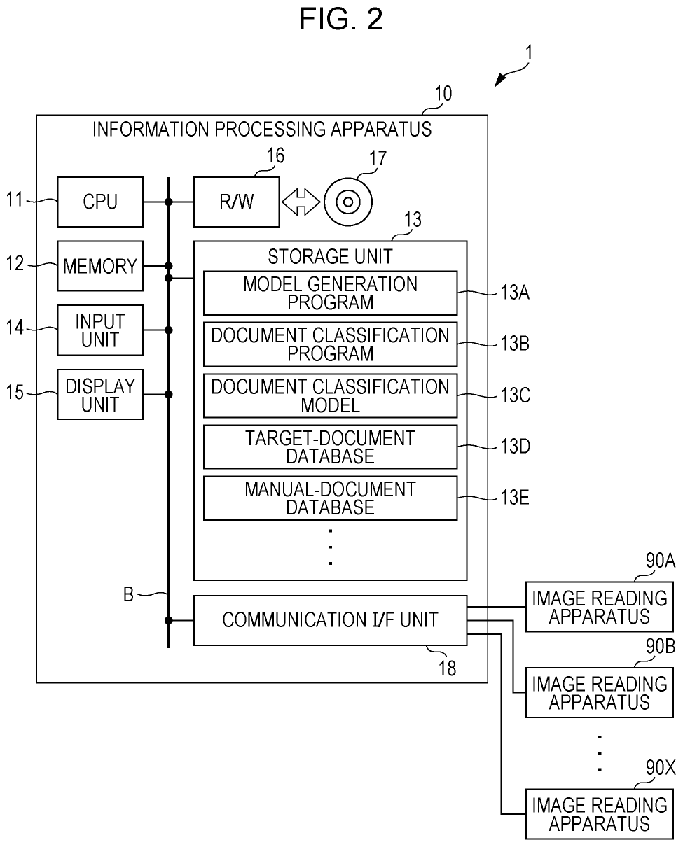

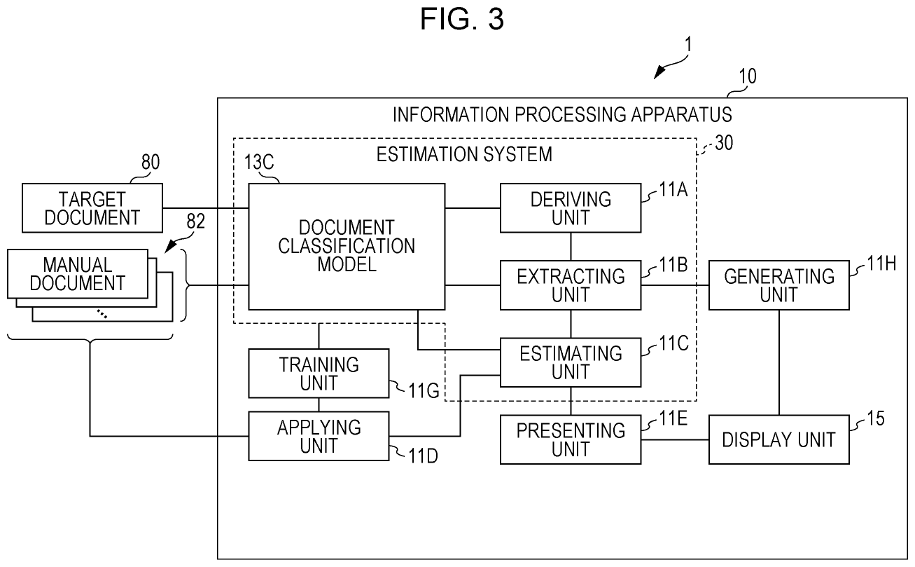

Referring to FIGS. 2 and 3, the configuration of the information processing apparatus 10 according to the first exemplary embodiment will be described. FIG. 2 is a block diagram illustrating an exemplary hardware configuration of the information processing apparatus 10 according to the first exemplary embodiment. FIG. 3 is a block diagram illustrating an exemplary functional configuration of the information processing apparatus 10 according to the first exemplary embodiment. Examples of the information processing apparatus 10 include computers, such as a personal computer and a server.

As illustrated in FIG. 2, the information processing apparatus 10 according to the first exemplary embodiment includes a central processing unit (CPU) 11 which is a processor, a memory 12 which serves as a temporary storage area, a nonvolatile storage unit 13, an input unit 14, such as a keyboard and a mouse, a display unit 15 such as a liquid-crystal display, a medium read/write apparatus (R/W) 16, and a communication interface (I/F) unit 18. The CPU 11, the memory 12, the storage unit 13, the input unit 14, the display unit 15, the medium read/write apparatus 16, and the communication I/F unit 18 are connected to each other through a bus B. The medium read/write apparatus 16 reads information written in a recording medium 17 and writes information to the recording medium 17.

The storage unit 13 is implemented, for example, by using a hard disk drive (HDD), a solid state drive (SSD), or a flash memory. The storage unit 13, which serves as a storage medium, stores a model generation program 13A and a document classification program 13B. The model generation program 13A is stored in the storage unit 13 in such a manner that the recording medium 17, in which the model generation program 13A has been written, is set to the medium read/write apparatus 16 which reads the model generation program 13A from the recording medium 17. The document classification program 13B is stored in the storage unit 13 in such a manner that the recording medium 17, in which the document classification program 13B has been written, is set to the medium read/write apparatus 16 which reads the document classification program 13B from the recording medium 17. The CPU 11 reads the model generation program 13A from the storage unit 13, loads the model generation program 13A on the memory 12, and sequentially performs processes included in the model generation program 13A. The CPU 11 reads the document classification program 13B from the storage unit 13, loads the document classification program 13B on the memory 12, and sequentially performs processes included in the document classification program 13B.

The storage unit 13 stores the document classification model 13C, and stores various databases, such as a target-document database 13D and a manual-document database 13E. The document classification model 13C, the target-document database 13D, and the manual-document database 13E will be described in detail below.

Referring to FIG. 3, the functional configuration of the information processing apparatus 10 according to the first exemplary embodiment will be described. As illustrated in FIG. 3, the information processing apparatus 10 includes a deriving unit 11A, an extracting unit 11B, an estimating unit 11C, an applying unit 11D, a presenting unit 11E, a training unit 11G, and a generating unit 11H. The CPU 11 of the information processing apparatus 10 executes the model generation program 13A and the document classification program 13B, functioning as the deriving unit 11A, the extracting unit 11B, the estimating unit 11C, the applying unit 11D, the presenting unit 11E, the training unit 11G, and the generating unit 11H.

In classification of a target document according to the classification criteria, the deriving unit 11A according to the first exemplary embodiment derives the degrees of significance of terms, which are included in the classification criteria, with respect to the terms included in the target document. In the first exemplary embodiment, multiple types of request-for-approval documents, such as a request-for-approval document for capital investment, a request-for-approval document for contract, a request-for-approval document for recruitment, and a request-for-approval document for purchase of appliance, are used as the target document. As the classification criteria, manual documents, which are documents that are prepared for the respective types of request-for-approval documents and that describe the rules for the corresponding request-for-approval documents, are used. However, this is not limiting. As the target document and a document for which a manual document describing about the target document is prepared, documents other than request-for-approval documents, such as an estimation sheet and a statement of accounts for expense, may be used.

The extracting unit 11B according to the first exemplary embodiment extracts significant terms from the terms in the classification criteria on the basis of the degrees of significance derived by the deriving unit 11A. In particular, the extracting unit 11B according to the first exemplary embodiment extracts, as significant terms, the terms which are included in the classification criteria and which have the degrees of significance equal to or greater than a predetermined threshold. In the first exemplary embodiment, both the sentences included in the manual documents and the words included in the sentences are used as the terms. However, this is not limiting. For example, only the words included in the manual documents may be used as the terms, or combinations of words may be used as the terms.

The deriving unit 11A according to the first exemplary embodiment derives the degrees of significance by using the source-target-attention mechanism for a target document and the classification criteria.

For each of the classification criteria, the deriving unit 11A according to the first exemplary embodiment derives the degrees of significance. For each of the classification criteria, the extracting unit 11B according to the first exemplary embodiment extracts the significant terms.

The estimating unit 11C according to the first exemplary embodiment uses the significant terms, which are extracted by the extracting unit 11B, to estimate, for each of the classification criteria, a probability of correspondence between a target document and the document indicated by the classification criterion. The applying unit 11D according to the first exemplary embodiment selects from the classification criteria, which correspond to documents, in the descending order of probability obtained in past estimation performed by the estimating unit 11C, and applies the selected classification criteria sequentially to an estimation system 30. The estimation system 30 includes deriving the degrees of significance by the deriving unit 11A, extracting significant terms by the extracting unit 11B, and estimating the probabilities by the estimating unit 11C.

Prior to the estimation performed by the estimating unit 11C, the training unit 11G according to the first exemplary embodiment uses actual target documents to train the estimation system 30. The presenting unit 11E according to the first exemplary embodiment presents, to a user, classification criteria in the descending order of probability estimated by the estimating unit 11C.

The generating unit 11H according to the first exemplary embodiment uses the significant terms, which are extracted by the extracting unit 11B, to generate summary sentences for the classification criteria. The generating unit 11H according to the first exemplary embodiment uses the significant terms to generate sentences, describing values for keys, as the summary sentences.

The presenting unit 11E according to the first exemplary embodiment presents the significant terms extracted by the extracting unit 11B. In addition to the significant terms, the presenting unit 11E according to the first exemplary embodiment presents the degrees of significance for the significant terms. The presenting unit 11E according to the first exemplary embodiment presents the significant terms along with the corresponding classification criteria.

The information processing system 1 according to the first exemplary embodiment employs presentation of display using the display unit 15 as presentation performed by the presenting unit 11E. This is not limiting. For example, when an image reading apparatus 90, which reads a target document, is equipped with a display unit, display on the display unit may be used as presentation performed by the presenting unit 11E. Presentation performed by the presenting unit 11E is not limited to presentation of display. For example, presentation of print made by an image forming apparatus or presentation using voice produced by a voice producing apparatus may be used.

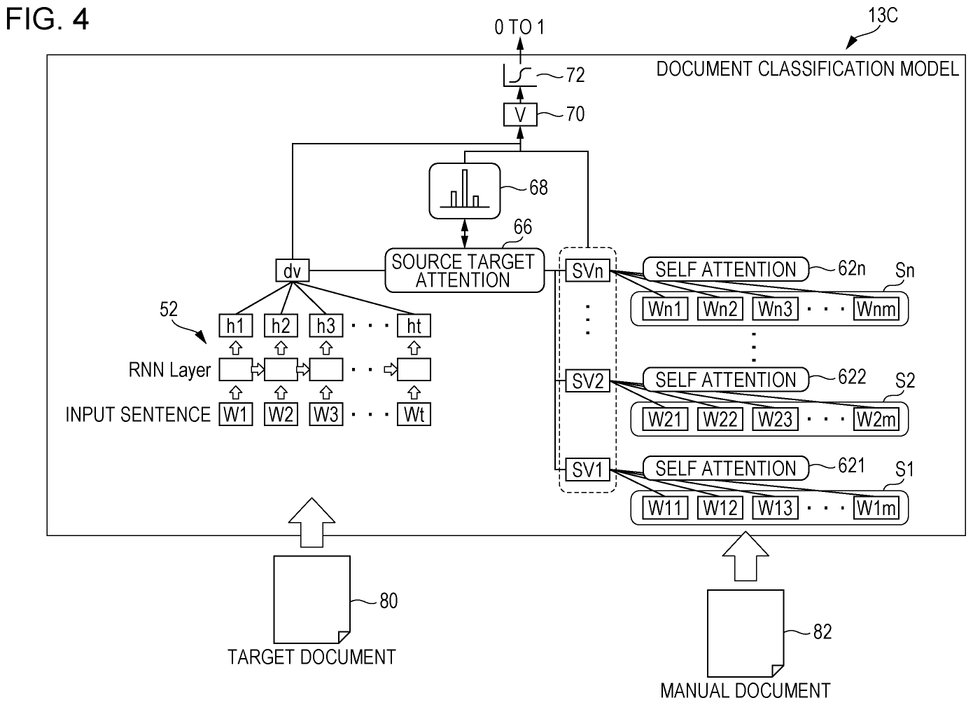

Referring to FIG. 4, the document classification model 13C according to the first exemplary embodiment will be described. FIG. 4 is a schematic diagram illustrating an exemplary configuration of the document classification model 13C according to the first exemplary embodiment.

As illustrated in FIG. 4, the document classification model 13C according to the first exemplary embodiment segments information, which is included in a target document 80, into words W1, W2, . . . , Wt. The document classification model 13C according to the first exemplary embodiment includes recurrent neural network (hereinafter referred to as “RNN”) layers 52 which convert the words W1, W2, . . . , Wt into vectors h1, h2, . . . , ht. The document classification model 13C according to the first exemplary embodiment integrates the vectors h1, h2, . . . , ht, which are obtained by the RNN layers 52, for conversion into a single vector dv corresponding to the target document 80.

In contrast, the document classification model 13C according to the first exemplary embodiment segments information, which is included in a manual document 82, into sentences S1, S2, . . . , Sn. The document classification model 13C according to the first exemplary embodiment segments the sentences S1, S2, . . . , Sn into words W11, W12, . . . , W1m, words W21, W22, . . . , W2m, . . . , and words Wn1, Wn2, . . . , Wnm, respectively. The document classification model 13C according to the first exemplary embodiment includes self-attention mechanisms 621, 622, . . . , 62n of deriving the degrees of significance of the words in each of the sentences S1, S2, . . . , Sn. The document classification model 13C according to the first exemplary embodiment integrates the degrees of significance of the words in each of the sentences S1, S2, . . . , Sn, which are obtained by the self-attention mechanisms 621, 622, . . . , 62n, for conversion into vectors SV1, SV2, . . . , SVn for the sentences.

The document classification model 13C according to the first exemplary embodiment includes a source-target attention mechanism 66 described above. The document classification model 13C according to the first exemplary embodiment derives a score (hereinafter referred to as “sentence score”) 68 for the degree of significance of each of the sentences S1, S2, . . . , Sn by using the source-target attention mechanism 66 which uses, as a target, the vector dv of the target document 80, and which uses, as a source, the vectors SV1, SV2, . . . , SVn for the sentences in the manual document 82.

The document classification model 13C according to the first exemplary embodiment uses the sentence scores 68, which are derived from the source-target attention mechanism 66, to adjust the vectors SV1, SV2, . . . , SVn for the sentences S1, S2, . . . , Sn in the manual document 82. The document classification model 13C according to the first exemplary embodiment merges the adjusted vectors SV1, SV2, . . . , SVn with the vector dv of the target document 80 to obtain a single final vector 70.

The document classification model 13C according to the first exemplary embodiment includes a sigmoid function 72. The document classification model 13C according to the first exemplary embodiment outputs the final vector 70 as a value from zero to one by using the sigmoid function 72 so as to derive a probability of correspondence between the target document 80 and the manual document 82.

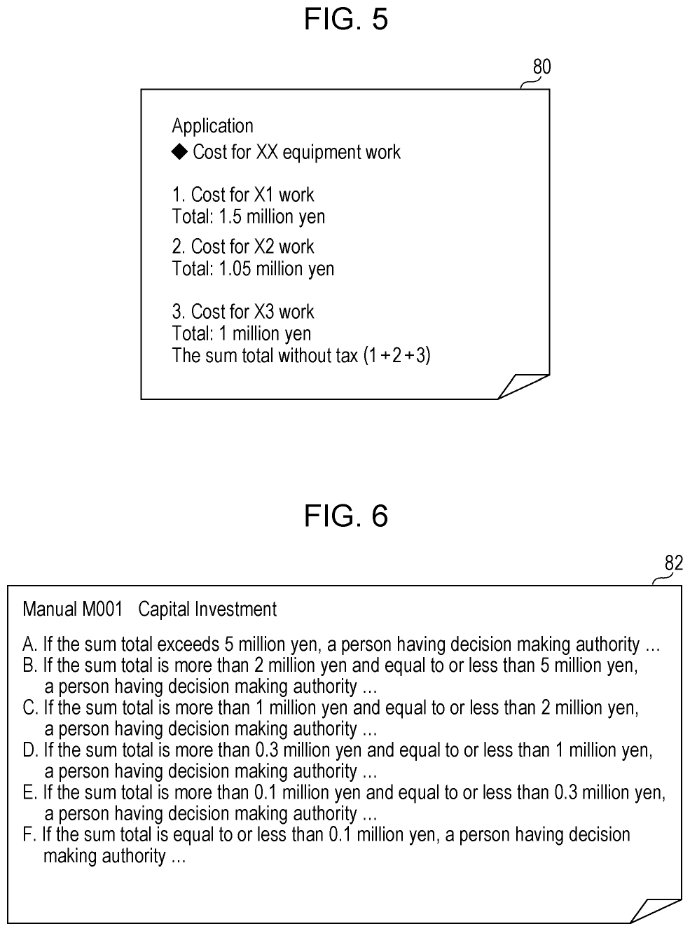

Referring to FIG. 5, the target document 80 according to the first exemplary embodiment will be described. FIG. 5 is a view of the front side of an example of the target document 80 according to the first exemplary embodiment.

As illustrated in FIG. 5, the target document 80 according to the first exemplary embodiment includes information indicating an application, and includes information indicating the costs of items related to the application and information indicating the total of the costs. In the example in FIG. 5, the application describes the cost for equipment work, and the costs of three types of work, X1, X2, and X3, are described as the costs of the items. The total of the cost of the three types of work is described as the total. Needless to say, this is not limiting.

Referring to FIG. 6, the manual document 82 according to the first exemplary embodiment will be described. FIG. 6 is a view of the front side of an example of the manual document 82 according to the first exemplary embodiment.

As illustrated in FIG. 6, the manual document 82 according to the first exemplary embodiment includes information describing application using a request-for-approval document which is the target of the manual document 82, and also includes information about who is to have decision making authority for the application. In the example in FIG. 6, the application is about capital investment. As the information about who is to have decision making authority, information about who has decision making authority in each amount range, which is obtained by dividing the amount into multiple ranges, is described. Needless to say, this is not limiting.

In the case of the manual document 82 in FIG. 6, sentences with alphabets (A, B, . . . ) at the beginning correspond to the sentences S1, S2, . . . , Sn, respectively.

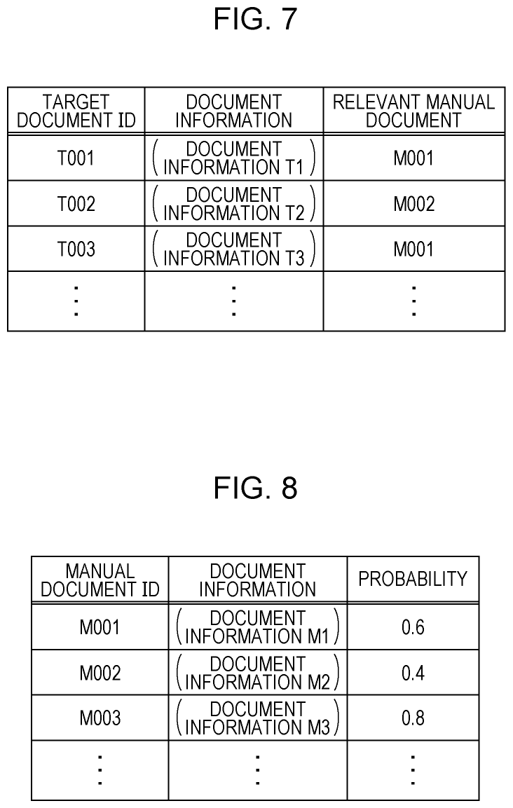

Referring to FIG. 7, the target-document database 13D according to the first exemplary embodiment will be described. FIG. 7 is a schematic diagram illustrating an exemplary configuration of the target-document database 13D according to the first exemplary embodiment.

The target-document database 13D according to the first exemplary embodiment is information used in training of the document classification model 13C. As illustrated in FIG. 7, in the target-document database 13D, pieces of information, that is, the target document identification (ID), the document information, and the relevant manual document, are stored in association with each other.

The target document ID is identification information assigned in advance to each target document for identification. The document information is information indicating the corresponding target document itself. The relevant manual document is information indicating a manual document corresponding to the corresponding target document.

In the first exemplary embodiment, information which directly indicates a target document itself is used as the document information. However, this is not limiting. For example, link information indicating the storage address of the corresponding target document may be used as the document information. In the first exemplary embodiment, the manual document ID which is described below and which is assigned in advance to the corresponding manual document is used as the relevant manual document. However, this is not limiting. Also in this case, for example, link information indicating the storage address of the corresponding manual document may be used as the relevant manual document instead of the manual document ID.

The example in FIG. 7 describes that the document information of a target document, to which “T001” is assigned as the target document ID, is “document information T1”, and that the target document corresponds to a manual document to which “M001” is assigned as the manual document ID.

Referring to FIG. 8, the manual-document database 13E according to the first exemplary embodiment will be described. FIG. 8 is a schematic diagram illustrating an exemplary configuration of the manual-document database 13E according to the first exemplary embodiment.

The manual-document database 13E according to the first exemplary embodiment is information used both in training of the document classification model 13C and in operation of the document classification model 13C. As illustrated in FIG. 8, pieces of information, that is, the manual document ID, the document information, and the probability, are stored in association with each other.

The manual document ID is identification information assigned in advance to each manual document for identification. The document information is information indicating the corresponding manual document itself. The probability is information indicating a probability of correspondence between the corresponding manual document and a target document.

In the first exemplary embodiment, information which directly indicates the manual document itself is used as the document information. However, this is not limiting. Also in this case, for example, link information indicating the storage address of the corresponding manual document may be used as the document information. In the first exemplary embodiment, the latest value of the probability of correspondence between any target document and the corresponding manual document, which is obtained through a document classification process that is described below and that is performed by using the document classification model 13C, is used as the probability. However, this is not limiting. For example, the average of the latest values (for example, ten values) of the probability may be used as the probability. In the first exemplary embodiment, a value in the range between zero and one is used as the probability. However, this is not limiting. Percent may be used as the probability.

The example in FIG. 8 describes that the document information of a manual document, to which “M001” is assigned as the manual document ID, is “document information M1”, and that the probability of correspondence between the manual document and a target document is 0.6 (that is, 60%).

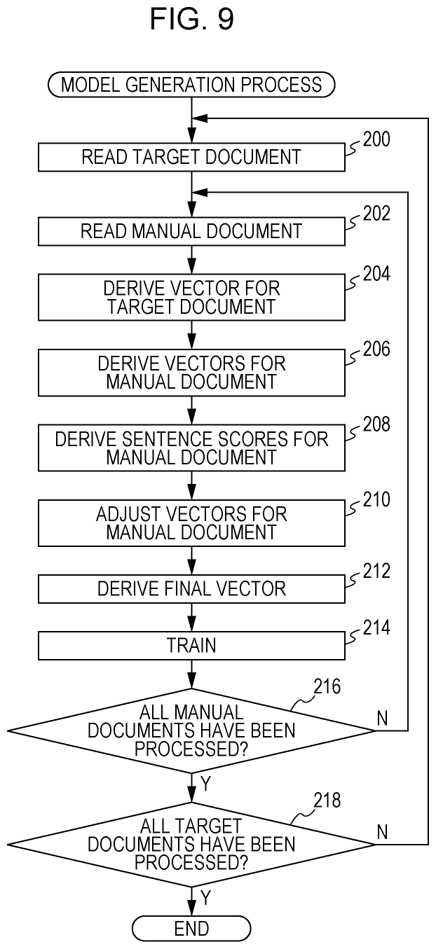

Referring to FIGS. 9 to 13, actions of the information processing apparatus 10 according to the first exemplary embodiment will be described. Referring to FIG. 9, actions of the information processing apparatus 10 in training of the document classification model 13C will be described. FIG. 9 is a flowchart of an exemplary model generation process according to the first exemplary embodiment. When a user of the information processing apparatus 10 inputs, through the input unit 14, an instruction to start execution of the model generation program 13A, the CPU 11 of the information processing apparatus 10 executes the model generation program 13A. Thus, the model generation process illustrated in FIG. 9 is performed. In this example, to avoid complicated description, the case in which the target-document database 13D and the manual-document database 13E have been already constructed will be described. To avoid complicated description, the case in which target documents (hereinafter referred to as “to-be-processed target documents”) and manual documents (hereinafter referred to as “to-be-processed manual documents”) which are used in training of the document classification model 13C are specified in advance will be described.

In step 200 in FIG. 9, the CPU 11 reads, from the target-document database 13D, the document information of any target document (hereinafter referred to as a “to-be-processed target document”) of the to-be-processed target documents and the relevant manual document corresponding to the target document. In step 202, the CPU 11 reads, from the manual-document database 13E, the manual document ID and the document information of any manual document (hereinafter referred to as a “to-be-processed manual document”) of the to-be-processed manual documents.

In step 204, the CPU 11 uses the RNN layers 52 of the document classification model 13C to derive the vector dv of the to-be-processed target document from its document information as described above. In step 206, the CPU 11 uses the self-attention mechanisms 621, 622, . . . , 62n of the document classification model 13C to derive the vectors SV1, SV2, . . . , SVn for the sentences in the to-be-processed manual document from its document information as described above. In step 208, the CPU 11 uses the source-target attention mechanism 66 of the document classification model 13C to derive the sentence scores 68 of the sentences of the to-be-processed manual document as described above.

In step 210, the CPU 11 uses the derived sentence scores 68 to adjust the vectors SV1, SV2, . . . , SVn for the sentences of the to-be-processed manual document. In step 212, the CPU 11 uses the vectors SV1, SV2, . . . , SVn of the to-be-processed manual document, which are obtained through the processes described above, and the vector dv of the to-be-processed target document to derive the final vector 70 as described above.

In step 214, the CPU 11 uses the value, which is output from the sigmoid function 72 of the document classification model 13C by using the derived final vector 70, to train the document classification model 13C in the following manner. That is, in the first exemplary embodiment, various parameters of the document classification model 13C are adjusted so that, when the to-be-processed manual document matches the manual document indicated by the relevant manual document which is read in step 200, the value which is output from the sigmoid function 72 is equal to one. In addition, the various parameters of the document classification model 13C are adjusted so that, when the to-be-processed manual document does not match the manual document indicated by the relevant manual document, the value which is output from the sigmoid function 72 is equal to zero. One adjustment process of the various parameters of the document classification model 13C corresponds to one training process.

In step 216, the CPU 11 determines whether all the to-be-processed manual documents registered in the manual-document database 13E have been subjected to the processes described above. If the determination result is negative, the process returns to step 202. If the determination result is positive in step 216, the process proceeds to step 218. In step 218, the CPU 11 determines whether all the to-be-processed target documents registered in the target-document database 13D have been subjected to the processes described above. If the determination result is negative, the process returns to step 200. If the determination result is positive in step 218, the model generation process ends.

In repeated execution of steps 200 to 218, in step 200, the CPU 11 reads, as a to-be-processed target document, a target document, which has not been processed, from the to-be-processed target documents. In repeated execution of steps 200 to 218, in step 202, the CPU 11 reads, as a to-be-processed manual document, a manual document, which has not been processed, from the to-be-processed manual documents for the same to-be-processed target document.

The model generation process described above enables the document classification model 13C to be trained by using all the to-be-processed target documents registered in the target-document database 13D and all the to-be-processed manual documents registered in the manual-document database 13E.

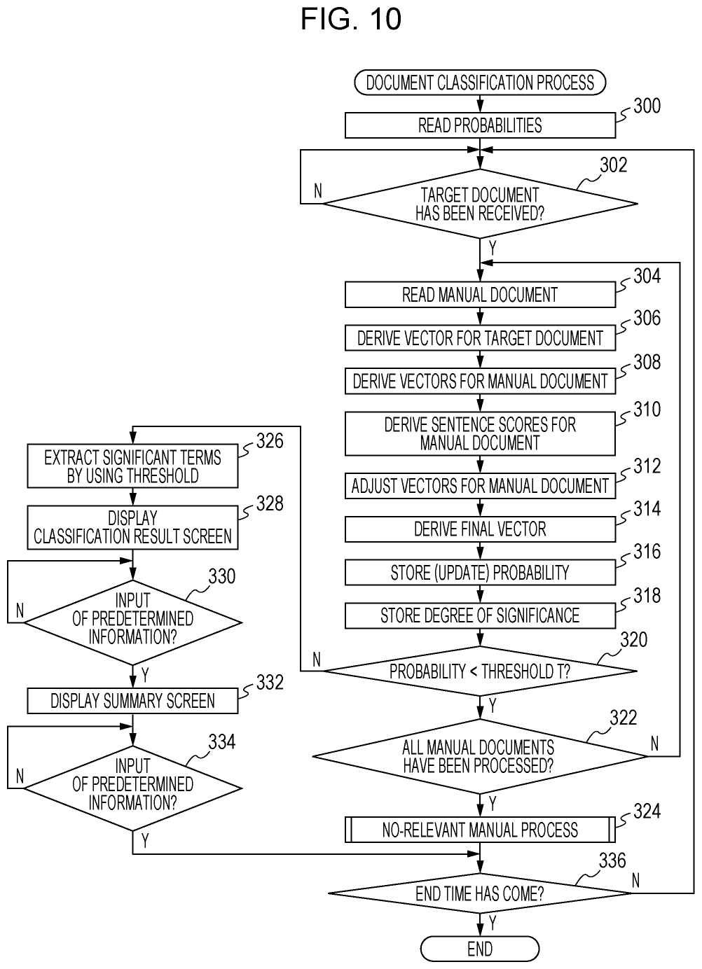

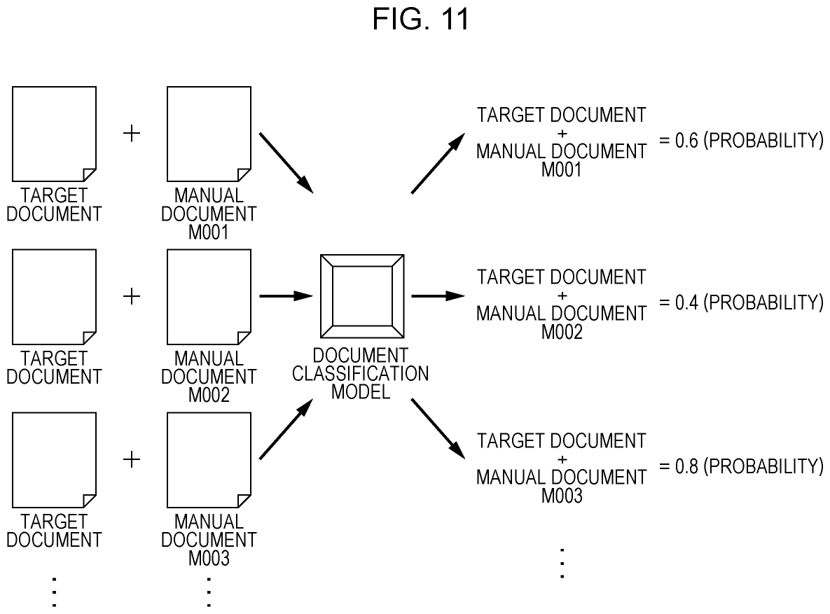

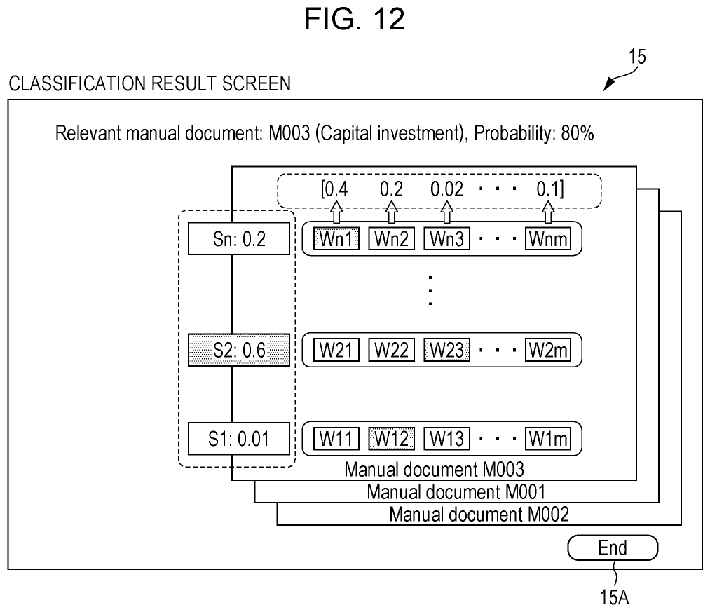

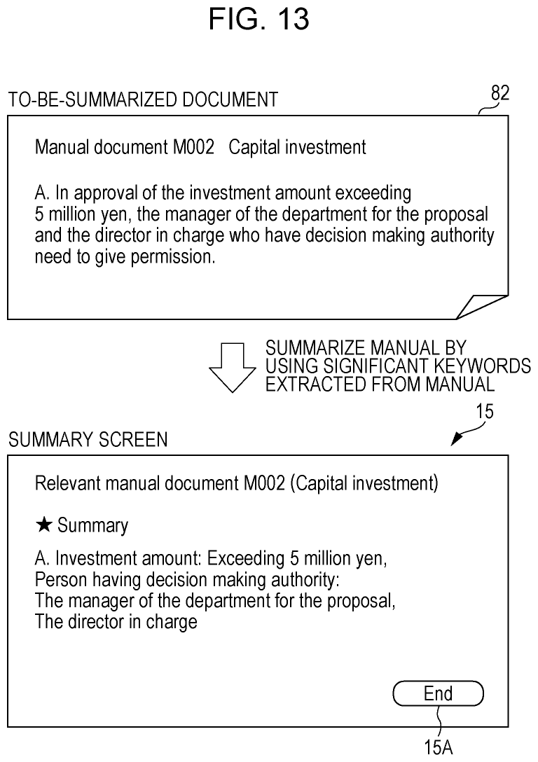

Referring to FIGS. 10 to 13, actions of the information processing apparatus 10 in operation of the document classification model 13C will be described. FIG. 10 is a flowchart of an exemplary document classification process according to the first exemplary embodiment. FIG. 11 is a diagram for describing the document classification process according to the first exemplary embodiment, and is a schematic diagram illustrating an exemplary state of estimation of probabilities of correspondence between a target document and the respective manual documents. FIG. 12 is a diagram illustrating an exemplary configuration of a classification result screen according to the first exemplary embodiment. FIG. 13 is a diagram illustrating an exemplary configuration of a summary screen according to the first exemplary embodiment.

When a user of the information processing apparatus 10 inputs, through the input unit 14, an instruction to start execution of the document classification program 13B, the CPU 11 of the information processing apparatus 10 executes the document classification program 13B. Thus, the document classification process illustrated in FIG. 10 is performed. In the example, to avoid complicated description, the case in which the manual-document database 13E has been already constructed will be described. To avoid complicated description, the case in which manual documents (hereinafter referred to as “classification-purpose manual documents”) used in classification of a target document are specified in advance will be described.

In step 300 in FIG. 10, the CPU 11 reads, from the manual-document database 13E, the probabilities of all the classification-purpose manual documents. In step 302, the CPU 11 waits until information indicating a target document (hereinafter referred to as a “received target document”) is received from any of the image reading apparatuses 90.

In step 304, the CPU 11 reads, from the manual-document database 13E, the document information of any one (hereinafter referred to as a “classification-purpose manual document”) of the classification-purpose manual documents. In this step, as a classification-purpose manual document, the CPU 11 reads, from the manual-document database 13E, a manual document having the highest probability, which has been read in step 300, among the classification-purpose manual documents.

In step 306, the CPU 11 uses the RNN layers 52 of the document classification model 13C to derive the vector dv of the received target document from its document information as described above. In step 308, the CPU 11 uses the self-attention mechanisms 621, 622, . . . , 62n of the document classification model 13C to derive the vectors SV1, SV2, . . . , SVn for the sentences of the classification-purpose manual document from its document information as described above. In step 310, the CPU 11 uses the source-target attention mechanism 66 of the document classification model 13C to derive the sentence scores 68 for the sentences of the classification-purpose manual document as described above.

In step 312, the CPU 11 uses the derived sentence scores 68 to adjust the vectors SV1, SV2, . . . , SVn for the sentences of the classification-purpose manual document as described above. In step 314, the CPU 11 derives the final vector 70 as described above by using the vectors SV1, SV2, . . . , SVn of the classification-purpose manual document which are obtained through the processes described above and the vector dv of the received target document.

In step 316, the CPU 11 obtains a value, which is output from the sigmoid function 72 of the document classification model 13C by using the derived final vector 70, as the probability of correspondence between the received target document and the document indicated by the classification-purpose manual document. In step 316, the CPU 11 stores (updates) the obtained probability as the probability corresponding to the classification-purpose manual document in the manual-document database 13E.

In step 318, the CPU 11 stores, in the storage unit 13, the sentence scores 68 for the sentences of the classification-purpose manual document which are obtained in step 310, as the values indicating the degrees of significance of the sentences. In step 318, the CPU 11 stores, in a word-by-word basis in the storage unit 13, information indicating the degrees of significance of the words in each sentence which are obtained by using the self-attention mechanisms 621 to 62n in the process of deriving the sentence scores 68.

In step 320, the CPU 11 determines whether the probability stored (updated) in step 316 is less than a predetermined threshold T. If the determination result is negative, the process proceeds to step 326. In contrast, if the determination result is positive, the process proceeds to step 322.

In the first exemplary embodiment, the threshold T is a fixed value which is set in advance so that, if the probability is equal to or greater than the threshold T, the received target document is regarded as corresponding to the document indicated by the classification-purpose manual document. However, this is not limiting. For example, in accordance with the accuracy or usage of document classification required for the document classification model 13C, the user of the information processing apparatus 10 may input the threshold T whenever necessary, or the threshold T may be set automatically.

In step 322, the CPU 11 determines whether all the classification-purpose manual documents have been subjected to the processes described above. If the determination result is negative, the process returns to step 304. If the determination result is positive, the process proceeds to step 324. In repeated execution of steps 304 to 322, in step 304, the CPU 11 reads, as the document information of a classification-purpose manual document, the document information of a manual document having the next highest probability to the classification-purpose manual document which has been just previously read.

The repeated processes in steps 304 to 322 cause a probability for a combination of a single received target document and each of the classification-purpose manual documents to be obtained by using the document classification model 13C, for example, as illustrated in FIG. 11.

In step 324, the CPU 11 performs a predetermined no-relevant manual process, and then the process proceeds to step 336. In the first exemplary embodiment, a process of displaying, on the display unit 15, a message that no relevant manual documents have been found is used as the no-relevant manual process. However, this is not limiting. For example, a process in which information indicating that no relevant request-for-approval documents have been found is presented by using at least one of the ways, that is, display, voice, and print, may be used as the no-relevant manual process.

In contrast, in step 326, the CPU 11 extracts, as significant terms, words and sentences, whose degrees of significance that are stored in step 318 are equal to or greater than a predetermined threshold, in the following manner.

For each of the classification-purpose manual documents, the CPU 11 reads the degrees of significance (that is, the sentence scores 68) of the sentences and the degrees of significance of the words which are stored in the storage unit 13 in step 318 from the start of this document classification process to this time point.

The CPU 11 extracts, as significant terms, sentences whose degrees of significance which have been read are equal to or greater than a predetermined threshold ST. In addition, the CPU 11 extracts, as significant terms, words whose degrees of significance which have been read are equal to or greater than a predetermined threshold WT.

In the first exemplary embodiment, the threshold ST is a fixed value which is set in advance so that, if the degree of significance of a sentence is equal to or greater than the threshold ST, the corresponding sentence is regarded as having a significance in the classification of the received target document. In the first exemplary embodiment, the threshold WT is a fixed value is set in advance so that, if the degree of significance of a word is equal to or greater than the threshold WT, the corresponding word is regarded as having a significance in the classification of the received target document. However, this is not limiting. For example, also in this case of these thresholds, in accordance with the accuracy or usage of word classification required for the document classification model 13C, the user of the information processing apparatus 10 may input the thresholds whenever necessary, or the thresholds may be set automatically.

In step 328, the CPU 11 controls the display unit 15 so that a classification result screen having a predetermined configuration is displayed by using information about the significant terms extracted in step 326. In step 330, the CPU 11 waits until predetermined information is input.

FIG. 12 illustrates an exemplary classification result screen according to the first exemplary embodiment. As illustrated in FIG. 12, a message that the document indicated by the latest-applied classification-purpose manual document is regarded as a document corresponding to the received target document, and its probability are displayed in the classification result screen according to the first exemplary embodiment. In the classification result screen according to the first exemplary embodiment, the degrees of significance of the sentences and the degrees of significance of the words are displayed for each classification-purpose manual document, which has been processed until this time point, in a state in which the sentences and words extracted in step 326 are emphasized. In particular, in the classification result screen according to the first exemplary embodiment, as illustrated in FIG. 12, the classification-purpose manual documents are displayed in the descending order of probability. Therefore, the user of the information processing apparatus 10 refers to the classification result screen to grasp the classification result of the received target document and grasp the sentences and words in the manual documents, from which the classification result is made, along with the degrees of significance of the sentences and words.

In the first exemplary embodiment, shaded display is used as the emphasized display. However, this is not limiting. For example, in addition to the shaded display, another display state, such as display with a color different from the others, blinking display, or reversed display, may be used alone or in combination. Instead of these display states, only the sentences and words which are extracted in step 326 may be displayed.

When the classification result screen, which is illustrated in FIG. 12 as an example, is displayed by the display unit 15, the user of the information processing apparatus 10 refers to the classification result screen, and then operates, through the input unit 14, an end button 15A displayed in the classification result screen. This operation causes the determination result in step 330 to be made positive, and the process proceeds to step 332.

In step 332, the CPU 11 generates summary sentences of the classification-purpose manual document (hereinafter referred to as the “to-be-summarized document”) having a probability equal to or greater than the threshold T. The CPU 11 controls the display unit 15 so that a summary screen having a predetermined configuration and illustrating the summary sentences is displayed. In step 334, the CPU 11 waits until predetermined information is input.

FIG. 13 illustrates an exemplary summary screen according to the first exemplary embodiment which is displayed when the to-be-summarized document is one illustrated in an upper part of FIG. 13. As illustrated in FIG. 13, in the summary screen according to the first exemplary embodiment, information indicating a to-be-summarized document (in the example in FIG. 13, “Relevant manual document M002 (capital investment)”) is displayed, and a summary sentence of the to-be-summarized document is displayed. In particular, in the summary screen according to the first exemplary embodiment, as a summary sentence, a sentence indicating a value (in the example in FIG. 13, “5 million yen”) corresponding to a key (in the example in FIG. 13, “investment amount”) is displayed by using the significant terms of the to-be-summarized document. Therefore, the user of the information processing apparatus 10 refers to the summary screen, achieving more effective grasp of the content of the to-be-summarized document.

When the summary screen, which is illustrated in FIG. 13 as an example, is displayed by the display unit 15, the user of the information processing apparatus 10 refers to the summary screen, and then operates, through the input unit 14, the end button 15A displayed in the summary screen. This operation causes the determination result in step 334 to be made positive, and the process proceeds to step 336.

In step 336, the CPU 11 determines whether a predetermined end time has come. If the determination result is negative, the process returns to step 302. In contrast, if the determination result is positive, the document classification process ends. In the first exemplary embodiment, the end time is when the user of the information processing apparatus 10 transmits an instruction to end the document classification process. However, this is not limiting. For example, when a predetermined time at which the document classification process is to end has come, or when the power supply of all the image reading apparatuses 90 which are the targets of the process is switched off, it may be determined that the end time has come.

### Second Exemplary Embodiment

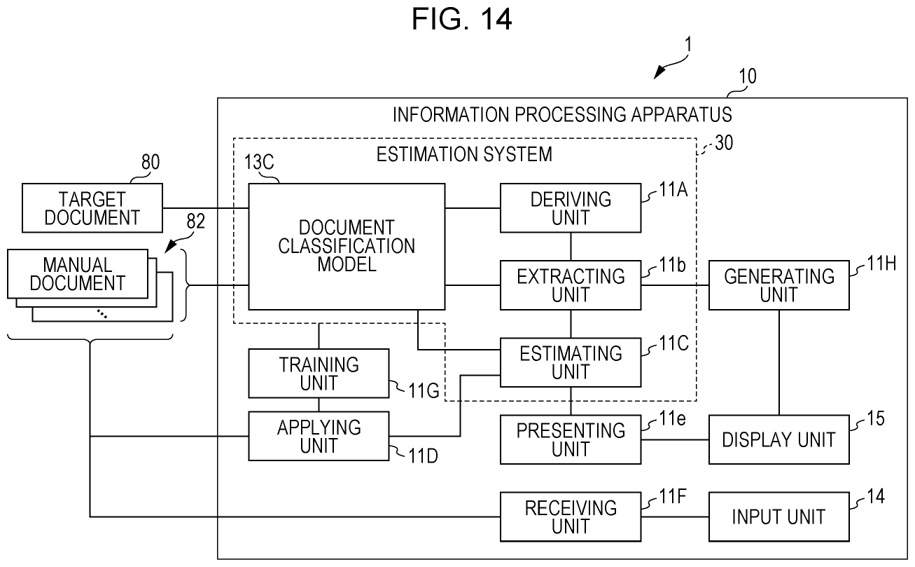

The configuration of the information processing system 1 according to a second exemplary embodiment, and the hardware configuration of the information processing apparatus 10 are substantially the same as those in the first exemplary embodiment (see FIGS. 1 and 2). Referring to FIG. 14, the functional configuration of the information processing apparatus 10 according to the second exemplary embodiment will be described. FIG. 14 is a block diagram illustrating an exemplary functional configuration of the information processing apparatus 10 according to the second exemplary embodiment. The components in FIG. 14 which are substantially the same as those in FIG. 3 are designated with the same reference characters as those in FIG. 3, and will not be described.

As illustrated in FIG. 14, the information processing apparatus 10 according to the second exemplary embodiment is different from that according to the first exemplary embodiment in that a receiving unit 11F is newly added, and that, instead of the extracting unit 11B and the presenting unit 11E, an extracting unit 11b and a presenting unit 11e are used.

The extracting unit 11b according to the second exemplary embodiment extracts, as significant terms, terms in each classification criterion in the descending order of the degree of significance derived by the deriving unit 11A.

The presenting unit 11e according to the second exemplary embodiment presents the classification criteria, which correspond to documents, in the descending order of probability estimated by the estimating unit 11C in the past. In accordance with presentation by the presenting unit 11e, the receiving unit 11F according to the second exemplary embodiment receives selection of a classification criterion, to which the estimation system 30 is to be applied.

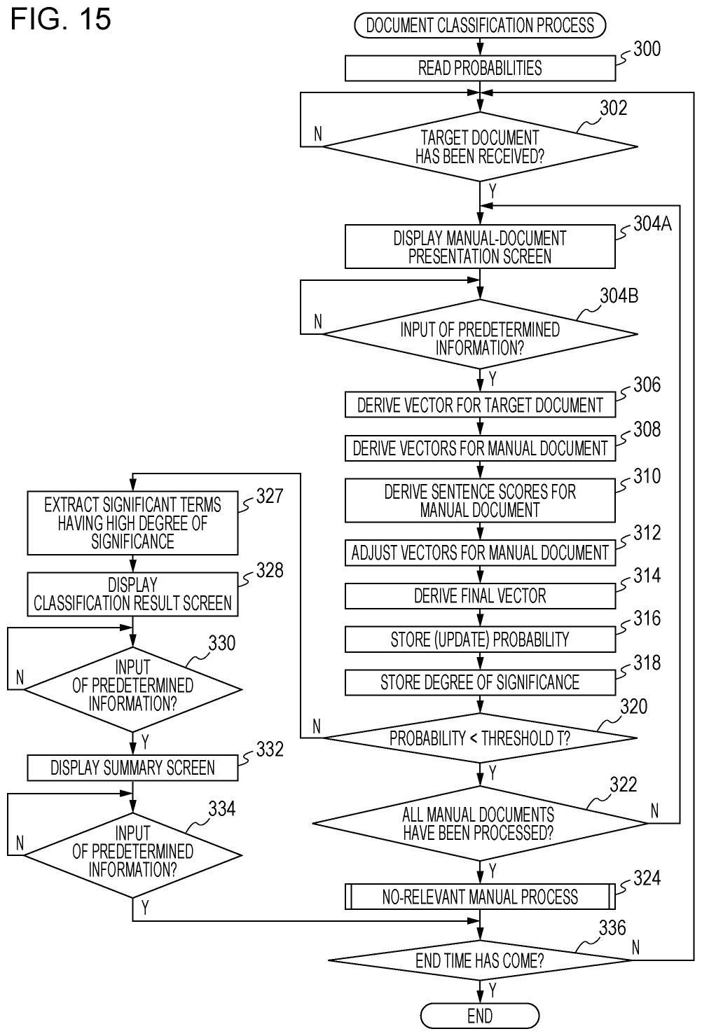

Actions of the information processing apparatus 10 according to the second exemplary embodiment will be described. The model generation process according to the second exemplary embodiment is substantially the same as that in the first exemplary embodiment, and will not be described. Referring to FIG. 15, actions of the information processing apparatus 10 according to the second exemplary embodiment in operation of the document classification model 13C will be described. FIG. 15 is a flowchart of an exemplary document classification process according to the second exemplary embodiment. Steps in FIG. 15, in which substantially the same processes as those in FIG. 10 are performed, are designated with the same step numbers as those in FIG. 10, and will not be described if possible.

As illustrated in FIG. 15, the document classification process according to the second exemplary embodiment is different from that in the first exemplary embodiment in that, instead of step 304, step 304A and step 304B are performed, and that, instead of step 326, step 327 is performed.

That is, in step 304A, the CPU 11 reads, from the manual-document database 13E, the document information of all the classification-purpose manual documents. In step 304A, the CPU 11 uses the document information and probabilities, which have been read, to control the display unit 15 so that a manual-document presentation screen having a predetermined configuration is displayed. In step 304B, the CPU 11 waits until predetermined information is input.

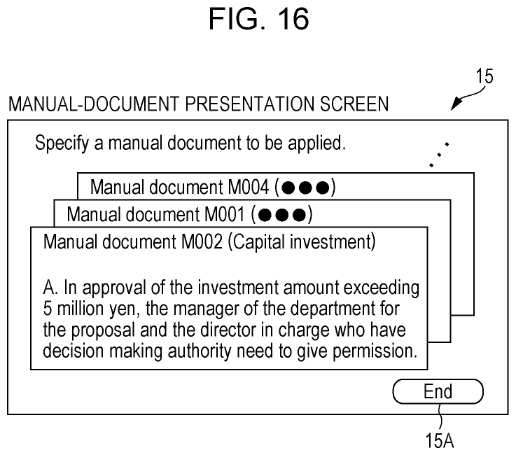

FIG. 16 illustrates an exemplary manual-document presentation screen according to the second exemplary embodiment. As illustrated in FIG. 16, in the manual-document presentation screen according to the second exemplary embodiment, a message for prompting selection of a manual document that is to be applied is displayed. In the manual-document presentation screen, information (in the example in FIG. 16, for example, “Manual document M002 (capital investment)”) indicating a manual document is displayed for each of the classification-purpose manual documents. In the manual-document presentation screen according to the second exemplary embodiment, the content of each of the classification-purpose manual documents is displayed.

In particular, in the manual-document presentation screen according to the second exemplary embodiment, the manual documents are displayed in the descending order of probability. In the example in FIG. 16, the manual document, to which M002 is assigned as the manual document ID, has the highest probability, and information about the manual document is displayed in the topmost layer. In the example in FIG. 16, the manual document, to which M001 is assigned as the manual document ID, has the second highest probability, and the manual document, to which M004 is assigned as the manual document ID, has the third highest probability. The manual documents are displayed in this sequence to the lower layer side in an overlapping manner on the background side. Therefore, the user of the information processing apparatus 10 refers to the manual-document presentation screen to specify a classification-purpose manual document more efficiently.

When the manual-document presentation screen, which is illustrated in FIG. 16 as an example, is displayed by the display unit 15, the user of the information processing apparatus 10 specifies, through the input unit 14, a manual document that is to be used as a classification-purpose manual document. Then, the user operates the end button 15A through the input unit 14. This operation causes the determination result in step 304B to be made positive, and the process proceeds to step 306. After that, the document information of the manual document specified by the user is used as the document information of the classification-purpose manual document.

In contrast, in step 327, the CPU 11 extracts, as significant terms, sentences and words in the descending order of the degree of significance stored in step 318. In the second exemplary embodiment, in the extraction of significant terms, a predetermined number of sentences and words are extracted in the descending order of the degree of significance. As a result, in the classification result screen displayed by the display unit 15 in step 328, the sentences and words extracted in step 327 are displayed in an emphasis manner as in the first exemplary embodiment.

### Third Exemplary Embodiment

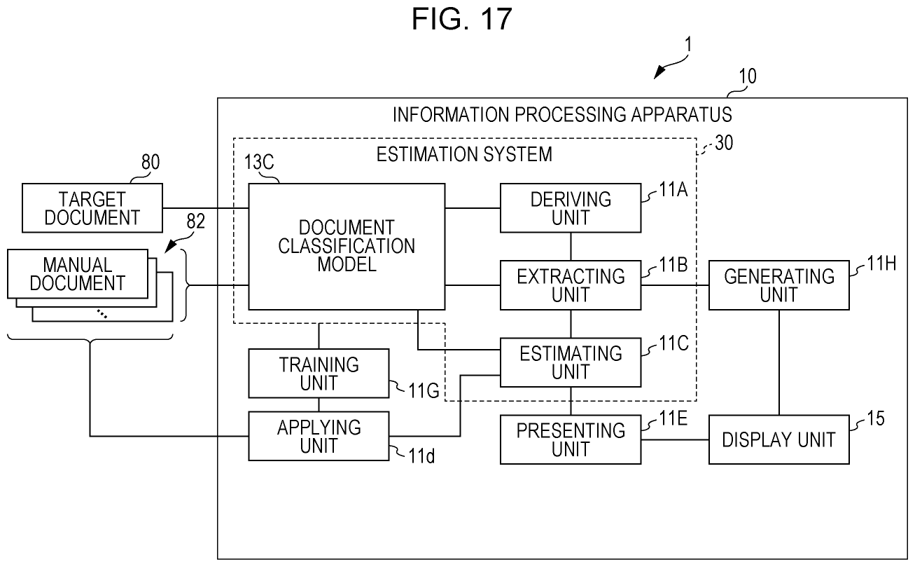

The configuration of the information processing system 1 according to a third exemplary embodiment, and the hardware configuration of the information processing apparatus 10 are substantially the same as those in the first exemplary embodiment (see FIGS. 1 and 2). Referring to FIG. 17, the functional configuration of the information processing apparatus 10 according to the third exemplary embodiment will be described. FIG. 17 is a block diagram illustrating an exemplary functional configuration of the information processing apparatus 10 according to the third exemplary embodiment. The components in FIG. 17 which are substantially the same as those in FIG. 3 are designated with the same reference characters as those in FIG. 3, and will not be described.

As illustrated in FIG. 17, the information processing apparatus 10 according to the third exemplary embodiment is different from that in the first exemplary embodiment in that, instead of the applying unit 11D, an applying unit 11d is used.

The applying unit 11d according to the third exemplary embodiment selects from the classification criteria, which correspond to documents, in the descending order of the number of target documents used in training of the document classification model 13C performed by the training unit 11G, and applies the selected classification criteria sequentially to estimation using the estimation system 30.

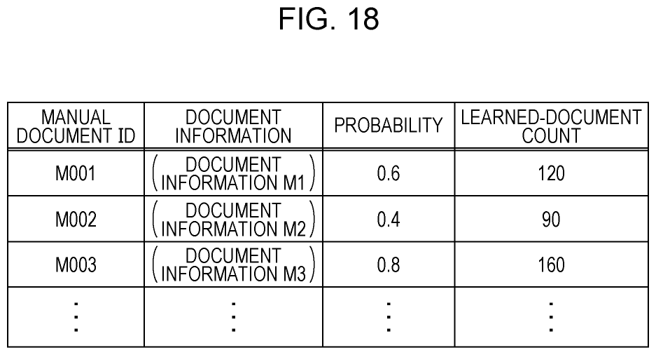

Referring to FIG. 18, the manual-document database 13E according to the third exemplary embodiment will be described. FIG. 18 is a schematic diagram illustrating an exemplary configuration of the manual-document database 13E according to the third exemplary embodiment.

As illustrated in FIG. 18, the manual-document database 13E according to the third exemplary embodiment is different from that in the first exemplary embodiment in that the learned-document count is further stored for each manual document.

The learned-document count is information indicating the number of target documents used in training of the document classification model 13C which is performed for the corresponding manual document.

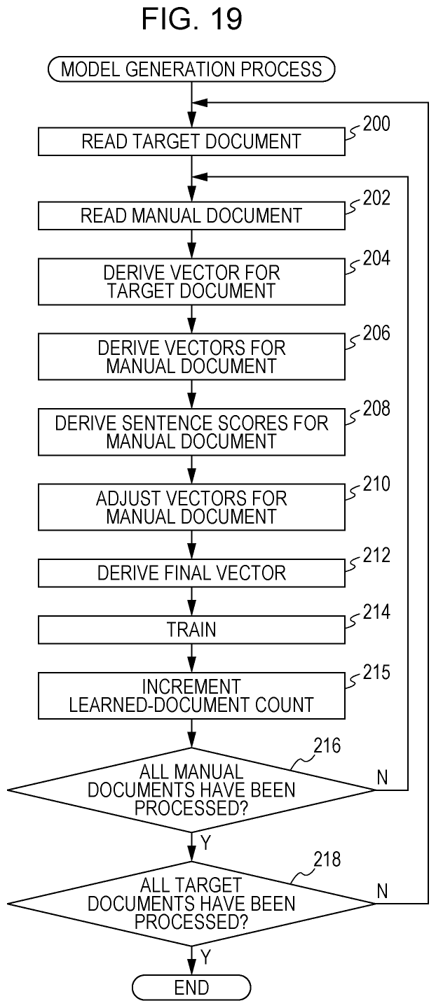

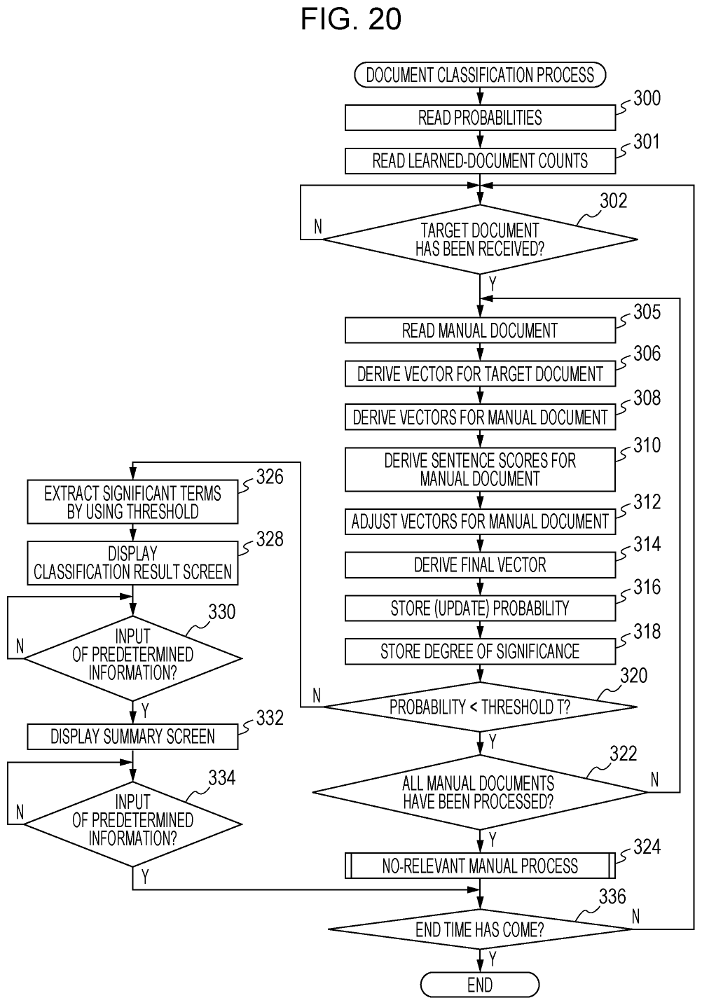

Referring to FIGS. 19 and 20, actions of the information processing apparatus 10 according to the third exemplary embodiment will be described. Referring to FIG. 19, actions of the information processing apparatus 10 in training of the document classification model 13C will be described. FIG. 19 is a flowchart of an exemplary model generation process according to the third exemplary embodiment. Steps in FIG. 19, in which substantially the same processes as those in FIG. 9 are performed, are designated with the same step numbers as those in FIG. 9, and will not be described.

As illustrated in FIG. 19, the model generation process according to the third exemplary embodiment is different from that in the first exemplary embodiment in that step 215 is newly added.

That is, in step 215, the CPU 11 increments, by one, the learned-document count in the manual-document database 13E which corresponds to the to-be-processed manual document. The process in step 215 causes the learned-document count in the manual-document database 13E to be incremented by one in every process of training the document classification model 13C using the to-be-processed manual document.

Referring to FIG. 20, actions of the information processing apparatus 10 according to the third exemplary embodiment in operation of the document classification model 13C will be described. FIG. 20 is a flowchart of an exemplary document classification process according to the third exemplary embodiment. Steps in FIG. 20, in which substantially the same processes as those in FIG. 10 are performed, are designated with the same step numbers as those in FIG. 10, and will not be described.

As illustrated in FIG. 20, the document classification process according to the third exemplary embodiment is different from that in the first exemplary embodiment in that step 301 is newly added, and in that, instead of step 304, step 305 is performed.

That is, in step 301, the CPU 11 reads, from the manual-document database 13E, the learned-document counts of all the classification-purpose manual documents. In step 305, as the document information of a classification-purpose manual document, the CPU 11 reads, from the manual-document database 13E, the document information of a manual document in the descending order of learned-document count which have been read.

In repeated execution of steps 305 to 322, in step 305, the CPU 11 reads, as the document information of a classification-purpose manual document, the document information of a manual document having the next largest learned-document count to the classification-purpose manual document which has been just previously read.

The exemplary embodiments are described. The technical scope of the present disclosure is not limited to the scope described in the exemplary embodiments. The exemplary embodiments may be changed or improved without departing from the gist of the disclosure. An embodiment obtained by making changes or improvements is also included in the technical scope of the present disclosure.

The exemplary embodiments do not limit the disclosure described in the claims. Not all the combinations of features described in the exemplary embodiments are necessary for the resolution in the disclosure. The exemplary embodiments include various stages of disclosure. A combination of disclosed components achieves extraction of various disclosures. Even when some of the components described in the exemplary embodiments are deleted, the configuration, from which the components are deleted, may be extracted as the disclosure as long as its effect is obtained.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the exemplary embodiments, the case in which the information processing system 1 includes multiple image reading apparatuses 90 is described. However, this is not limiting. For example, the information processing system 1 may include a single image reading apparatus 90.

In the exemplary embodiments, the case in which a target document 80, which is used in operation of the document classification model 13C, is not used in training of the document classification model 13C is described. The present disclosure is not limited to this. For example, a target document 80 which is used in operation of the document classification model 13C may be used in training of the document classification model 13C.

In the exemplary embodiments, the case in which the model generation process and the document classification process are implemented by using a software configuration using a computer through execution of programs is described. However, the present disclosure is not limited to this. For example, the model generation process and the document classification process may be implemented by using a hardware configuration or a combination of a hardware configuration and a software configuration.

Needless to say, the configuration of the information processing apparatus 10 described in the exemplary embodiments is exemplary. Without departing from the gist of the present disclosure, unnecessary parts may be deleted, or new parts may be added.

Needless to say, the flows of the model generation process and the document classification process described in the exemplary embodiments are exemplary. Without departing from the gist of the present disclosure, unnecessary steps may be deleted, new steps may be added, and the process sequence may be changed.

What is claimed is:

1. An information processing apparatus comprising:
a processor configured to,
in classification of a target document according to at least one classification criterion, extract significant terms from classification-criterion terms on a basis of degrees of significance of the classification-criterion terms relative to target-document terms, the classification-criterion terms being included in the at least one classification criterion, the target-document terms being included in the target document.

2. The information processing apparatus according to claim 1,
wherein the processor is configured to
extract, as the significant terms, classification-criterion terms having a degree of significance equal to or greater than a predetermined threshold.

3. The information processing apparatus according to claim 1,
wherein the processor is configured to
extract, as the significant terms, classification-criterion terms sequentially in a descending order of the degree of significance.

4. The information processing apparatus according to claim 2,
wherein the processor is configured to
extract, as the significant terms, classification-criterion terms sequentially in a descending order of the degree of significance.

5. The information processing apparatus according to claim 1,
wherein the processor is configured to
derive the degrees of significance by using a source-target attention mechanism for the target document and the at least one classification criterion.

6. The information processing apparatus according to claim 2,
wherein the processor is configured to
derive the degrees of significance by using a source-target attention mechanism for the target document and the at least one classification criterion.

7. The information processing apparatus according to claim 3,
wherein the processor is configured to
derive the degrees of significance by using a source-target attention mechanism for the target document and the at least one classification criterion.

8. The information processing apparatus according to claim 4,
wherein the processor is configured to
derive the degrees of significance by using a source-target attention mechanism for the target document and the at least one classification criterion.

9. The information processing apparatus according to claim 1,
wherein the at least one classification criterion comprises a plurality of classification criteria, and
wherein the processor is configured to
derive the degrees of significance by using each of the plurality of classification criteria as a target, and
extract the significant terms by using each of the plurality of classification criteria as a target.

10. The information processing apparatus according to claim 2,
wherein the at least one classification criterion comprises a plurality of classification criteria, and
wherein the processor is configured to
derive the degrees of significance by using each of the plurality of classification criteria as a target, and
extract the significant terms by using each of the plurality of classification criteria as a target.

11. The information processing apparatus according to claim 9,
wherein the processor is configured to
use the extracted significant terms to estimate, for each of the plurality of classification criteria, a probability of correspondence between the target document and a document indicated by the classification criterion, and
select from the plurality of classification criteria corresponding to the documents in a descending order of probability estimated in the past, and apply the selected classification criteria sequentially to an estimation system, the estimation system including deriving the degree of significance, extraction of the significant terms, and estimation of the probability.

12. The information processing apparatus according to claim 9,
wherein the processor is configured to
use the extracted significant terms to estimate, for each of the plurality of classification criteria, a probability of correspondence between the target document and a document indicated by the classification criterion,
present the classification criteria corresponding to the documents in a descending order of probability estimated in the past, and
receive selection of a classification criterion which is to be applied to an estimation system including deriving the degree of significance, extraction of the significant terms, and estimation of the probability, the selection being made in accordance with the presentation.

13. The information processing apparatus according to claim 9,
wherein the processor is configured to
use the extracted significant terms to estimate, for each of the plurality of classification criteria, a probability of correspondence between the target document and a document indicated by the classification criterion,
prior to the estimation, use the target document to train an estimation system including deriving the degree of significance, extraction of the significant terms, and estimation of the probability, the target document being used actually, and
select from the plurality of classification criteria corresponding to the documents in a descending order of target document count, and use the selected classification criteria sequentially as a target of estimation performed by the estimation system, the target document count indicating a count of target documents used in the training.

14. The information processing apparatus according to claim 9,
wherein the processor is configured to
use the extracted significant terms to estimate, for each of the plurality of classification criteria, a probability of correspondence between the target document and a document indicated by the classification criterion, and
present, to a user, the classification criteria in a descending order of probability.

15. The information processing apparatus according to claim 1,
wherein the processor is configured to
generate a summary sentence of the at least one classification criterion by using the extracted significant terms.

16. The information processing apparatus according to claim 15,
wherein the processor is configured to
generate, as the summary sentence, a sentence indicating a value for a key by using the significant terms.

17. The information processing apparatus according to claim 1,
wherein the processor is configured to
present the extracted significant terms.

18. The information processing apparatus according to claim 17,
wherein the processor is configured to
present the significant terms and the degrees of significance for the significant terms.

19. The information processing apparatus according to claim 17,
wherein the processor is configured to
present the significant terms along with the corresponding at least one classification criterion.

20. A non-transitory computer readable medium storing a program causing a computer to execute a process for information processing, the process comprising:
in classification of a target document according to at least one classification criterion, extracting significant terms from classification-criterion terms on a basis of degrees of significance of the classification-criterion terms relative to target-document terms, the classification-criterion terms being included in the at least one classification criterion, the target-document terms being included in the target document.
